(19) United States
(12) Patent Application Publication
(10) Pub. No.: US 2014/0187397 A1
(43) Pub. Date: Jul. 3, 2014

(54) MACHINE TOOL AND TOOL REPLACEMENT METHOD

(71) Applicant: MAG IAS GmbH, Goeppingen (DE)

(72) Inventors: Tobias Abeln, Stuttgart (DE); Walter Pompe, Gingen/Fils (DE); Benedikt Ell, Geislingen (DE); Markus Gunzenhauser, Boehmenkirch (DE); Gerhard Hommel, Geislingen (DE)

(73) Assignee: MAG IAS GmbH, Goeppingen (DE)

(21) Appl. No.: 14/200,560

(22) Filed: Mar. 7, 2014

Related U.S. Application Data
(63) Continuation of application No. PCT/EP2012/067310, filed on Sep. 5, 2012.

(30) Foreign Application Priority Data
Sep. 9, 2011 (DE) 102011053467.9

(51) Int. Cl. B23Q 3/157; B23Q 3/155

(52) U.S. Cl. CPC B23Q 3/1572; B23Q 3/15513; B23Q 3/15526
USPC 483/1; 483/36; 483/37

(57) ABSTRACT

There is provided a machine tool which includes a machine frame, at least one tool spindle which is arranged on the machine frame and is displaceable relative thereto, a workpiece holder and a storage device for tools which is arranged on the machine frame, wherein a chain-type storage device communicates with the storage device and the at least one tool spindle.

### CROSS-REFERENCE TO RELATED APPLICATIONS

The present application is a continuation of international application number PCT/EP2012/067310, filed on Sep. 5, 2012, which claims the benefit of German patent application number 10 2011 053 467.9, filed Sep. 9, 2011, the entire specification of both being incorporated herein by reference.

### BACKGROUND OF THE INVENTION

The invention relates to a machine tool which comprises a machine frame, at least one tool spindle which is arranged on the machine frame and is displaceable relative thereto, a workpiece holder and a storage device for tools which is arranged on the machine frame.

The invention also relates to a method for tool replacement.

From DE 90 14 433 U1 there is known a machine tool for machining processing by means of rotating tools, which also has a machine bed. In addition to a vertical work spindle, a tool changer with a double grip is provided at a headstock.

From DE 102 57 151 A1 there is known a machine tool for metal-removing machining of workpieces by a machining unit having at least one machining spindle, wherein a tool magazine is provided which serves for storing and replacing the tools at the machining spindle. The tool magazine is held by a support beam which penetrates the tool magazine.

From 102 25 143 A1 there is known a machine tool having a tool spindle which is movable in at least a first and a second axis and is designed to receive tools, a background magazine in which tools are stored and a transfer device which moves the tools between the background magazine and a transfer position. A machine magazine for receiving tools is provided on the machine tool and from which tools in the tool spindle are replaced. The transfer position is associated with the machine magazine in such a way that the transfer device exchanges tools between the background magazine and the machine magazine.

### SUMMARY OF THE INVENTION

In accordance with the present invention, a machine tool is provided in which an efficient tool change can be carried out with short chip-to-chip times.

In accordance with an embodiment of the invention, a chain-type storage device is provided which communicates with the storage device and with the at least one tool spindle.

The storage device on the machine frame constitutes a background magazine for tools. The chain-type storage device constitutes a buffer store for tools. A very large number of tools can be stored directly on the machine tool, on the storage device which constitutes the background magazine. The number of storage spaces on the chain-type storage device is smaller in order to enable efficient tool changing. However, it is possible to store as many tools as needed so that even complex machining operations, for which several different tools are necessary, can be carried out with short chip-to-chip times. A chain-type storage device can be configured to be relatively space-saving, even if a plurality of storage spaces (for example, 50 or more) are available. In particular, a chain-type storage device can be configured in a length such that a plurality of tool spindles (for example, two spindles) can be serviced.

With a chain-type storage device, it is possible, in particular, to carry out a tool replacement operation at the at least one tool spindle and a tool change between the storage device and the chain-type storage device. In this way, therefore, the already existing machining idle times necessary for a tool replacement at the at least one tool spindle can be used efficiently for a tool change between the storage device and the chain-type storage device.

Different storage spaces can be treated differently on a chain-type storage device. In particular, certain storage spaces can be lifted out, particularly where such spaces are in a particular position, that is, said spaces can be displaced in a direction parallel to the at least one tool spindle. In this way, a tool replacement can be carried out at the at least one tool spindle. Other storage spaces are not affected by this lifting-out movement, so that, in particular, a tool replacement between the storage device and the chain-type storage device can be performed during this period.

It is also possible for a plurality of storage spaces to be lifted out per tool spindle at the chain-type storage device. In this way, for example, a storage space can be configured as a bring space for a tool to the tool spindle and a storage space can be configured as a fetch space for a tool from the tool spindle. By this means, the travel times during a tool replacement procedure at the at least one tool spindle can be kept small. This contributes to a low chip-to-chip time.

In particular, the chain-type storage device is associated with at least one first tool spindle and a second tool spindle. The same chain-type storage device enables a tool change to be carried out both at the first tool spindle and also at the second tool spindle. This tool change can also take place synchronously for both the tool spindles.

In particular, the storage device constitutes a first magazine (background magazine) for tools and the chain-type storage device constitutes a second magazine (buffer magazine) for tools. In this way, firstly a large number of tools can be stored at the machine tool and, secondly, an efficient tool change can be carried out.

In particular, a storage capacity of the first magazine for tools is greater than the storage capacity of the chain-type storage device. In this way, firstly a large number of tools can be stored on the machine tool and, secondly, a time-efficient tool replacement can be carried out by means of the second magazine.

In one embodiment, the storage device comprises at least 30 storage spaces for tools. In particular, the storage device comprises at least 50, and preferably at least 80 storage spaces.

In a further embodiment, the chain-type storage device comprises, for example, in the range of 30 to 50 storage spaces for tools.

In particular, the storage device has a region with storage spaces which lies above a working space and has a region which lies beside the working space. Using the region above the working space, tools can be made available to the chain-type storage device. Using the region beside the working space, tools can be fed to and removed from the storage device. For example, they can be fed in and removed manually.

If manual feeding is provided for, then it is particularly advantageous if the region lying beside the working space is at a spacing of not more than 1.5 m from a foundation on which the machine bed stands. A tool therefore does not have to be lifted “above the head” of an operator. In principle, the smaller the spacing from the floor, the greater is the storage capacity. A small spacing can also be advantageous in the case of automatic supplying and removal of tools.

For example, the storage device has an L-shaped form in plan view. The region above the working space and the region beside the working space are oriented transversely to one another.

It is favorable if the storage device comprises a circulating conveyor which is configured, in particular, as a chain conveyor. In this way, a storage capacity can be achieved over essentially the whole surface of the storage device. An endless construction using a circulating conveyor enables tools to be transported in a simple way and, for example, to be fed to the chain-type storage device.

It is particularly advantageous if the chain-type storage device comprises a circulating chain conveyor. The chain is configured endless. Storage spaces can be transported by means of a suitable circulation, in order to feed and carry away particular tools to and from a tool spindle.

It is particularly advantageous if the chain-type storage device comprises a lifting-out device by means of which one or more storage spaces and/or tools are displaceable in a direction parallel to a longitudinal direction of the at least one tool spindle. The lifting-out device can act upon a storage space and displace a tool by displacing said storage space, or can act directly upon a tool. By means of the lifting-out device, a tool can be positioned relative to the tool spindle in relation to the direction parallel to a longitudinal direction of the tool spindle. A tool replacement can thus be carried out more rapidly and more efficiently. The lifting-out device can carry out the corresponding displacement in the direction parallel to the longitudinal direction of the at least one tool spindle for a subset of all the storage spaces of the chain-type storage device, so that the corresponding displacement movement does not need to be carried out for all the storage spaces of the chain-type storage device. This makes it possible for a tool change to be carried out between the chain-type storage device and the storage device simultaneously with a tool change at the at least one tool spindle. The result is short tool replacement times and the time required for a tool change at the at least one tool spindle can be used efficiently. It is also possible, using the lifting-out device, for a lifted-out tool or a lifted-out storage space to be approached directly by the at least one tool spindle. In this way, the process of fetching a tool by the at least one tool spindle at the chain-type storage device and the process of bringing a tool from the at least one tool spindle to the chain-type storage device can be carried out in an efficient and time-saving manner.

In particular, the lifting-out device provides a lifting-out travel in the range between 20 mm and 60 mm. In this way, efficient releasing and fixing of a tool to a tool spindle can be achieved.

It is particularly advantageous if the lifting-out device comprises at least one first lifting-out region and a second lifting-out region by means of which one or more storage spaces and/or tools can be lifted out synchronously, wherein in particular the first lifting-out region is associated with a first tool spindle and the second lifting-out region is associated with a second tool spindle. A lifting-out movement can thus be carried out by means of a lifting-out device in spatially separate regions of the chain-type storage device, in order to enable synchronous tool change simultaneously at the first tool spindle and also at the second tool spindle. This results in short chip-to-chip times and time-efficient workpiece machining.

The first lifting-out region and the second lifting-out region are arranged symmetrically to one another.

For example, the lifting-out device is arranged so as to be able to lift out one or more storage spaces and/or tools which are positioned at a bottom side of the chain-type storage device which is associated with a machine bed. The storage spaces, which can be lifted out accordingly, can be directly approached by a tool spindle in order to enable a time-efficient tool change.

In one exemplary embodiment, the lifting-out device comprises at least one displaceable spindle which is associated with one or more storage spaces of the chain-type storage device. The at least one displaceable spindle allows a lifting-out travel to be provided to bring about a displacement movement. For example, a single displaceable spindle is provided.

It is advantageous, in particular, if at least two (in particular adjacently arranged) storage spaces and/or tools can be lifted out by the lifting-out device. For example, a corresponding storage space is a bring space and an adjacent storage space is a fetch space. By means of the lifting-out device, the bring space and the fetch space can be brought into the corresponding lifting-out position. The fetch space can be approached by the at least one tool spindle and a tool can be deposited directly thereat. The at least one tool spindle can then approach the bring space and fetch the new tool there. The lifting-out device does not itself have to carry out any movement between approaching the fetch space and the bring space since the lifting-out position is reached by one movement process for both the bring space and for the fetch space.

In particular, a displacement actuator is associated with the at least one spindle. Said actuator can comprise, for example, a motor drive, a fluid drive, a spring drive or the like.

For example, the at least one displacement actuator comprises a drive such as, for example, a motor drive or a fluid drive.

In an exemplary embodiment, the at least one spindle is part of a lead screw drive. This lead screw drive comprises, in particular, a servomotor. In addition to driving an advancing movement in order to reach the lifting-out position and a corresponding return stroke movement, said displacement actuator with servomotor and lead screw drive can also determine the positions shown (lifting-out position and non-extended position).

Favorably, the at least one transfer station is movable between the storage device and the at least one chain-type storage device. In this way, tools can be transported between the storage device and the chain-type storage device.

In particular, the chain-type storage device is arranged and configured such that, at the same time as a tool replacement at the at least one tool spindle, a tool change can be carried out between the storage device and the chain-type storage device. In this way, the machining idle times necessary for a tool change at the at least one tool spindle can be used efficiently for a tool change between the storage device and the chain-type storage device.

In accordance with the invention, a method for tool replacement is provided which results in minimized chip-to-chip times.

In accordance with an embodiment of the invention, the at least one tool spindle approaches the chain-type storage device, wherein a storage space and/or a tool is lifted out at the chain-type storage device in a direction parallel to an axis of the at least one tool spindle.

The method according to the invention has the advantages set out above in relation to the machine tool according to the invention.

Further advantageous embodiments have also already been set out above in relation to the machine tool according to the invention.

In particular, the method according to the invention can be carried out on the machine tool according to the invention.

By means of a chain-type storage device, it is possible, without any circulating motion, simultaneously to carry out a tool change operation at the at least one tool spindle and a tool change between the storage device and the chain-type storage device. This is achieved in that only a partial region of the chain-type storage device has to be lifted out for a tool replacement between the at least one tool spindle and the chain-type storage device.

This makes it possible for a tool change to be carried out between the storage device and the chain-type storage device simultaneously with a tool replacement between the at least one tool spindle and the chain-type storage device. This results in short chip-to-chip times, even when complex machining operations have to be carried out with a plurality of tools on workpieces.

It is favorable if, for a tool change at the at least one tool spindle, at least one bring space for a tool and one fetch space for a tool are lifted simultaneously. In this way, a tool hand-over by the at least one tool spindle and a tool collection by the at least one tool spindle can be carried out by a displacement movement of the at least one tool spindle, in particular, in one direction (X-direction) without a movement of a corresponding lifting-out device in the direction parallel to the axis of the at least one tool spindle (Z-axis) being required during these displacement movements.

The invention will now be described in greater detail making reference to preferred embodiments and the drawings.

### BRIEF DESCRIPTION OF THE DRAWINGS

FIG. 1 shows a perspective partial view of an exemplary embodiment of a machine tool according to the invention (without the cover and with a partial representation of a storage device), wherein tools are indicated by an interfering contour;

FIG. 2 shows the machine tool of FIG. 1 in a side view;

FIG. 3 shows the machine tool of FIG. 1 in a front view;

FIG. 4 shows an exemplary embodiment of a storage device (first magazine) with disk-type storage units (second magazine) in the machine tool of FIG. 1;

FIG. 5 shows a view of the storage system of FIG. 4 from another side;

FIG. 6 shows a second exemplary embodiment of a storage system wherein tools are indicated by an interfering contour;

FIG. 7 shows a view of a chain-type storage device according to FIG. 6 in the direction A and in a lifting-out position;

FIG. 8 shows the same view as FIG. 7 in a not lifted-out position;

FIG. 9 shows a sectional view along the line 9,10-9,10 according to FIG. 6 in the lifted-out position;

FIG. 10 shows the same view as FIG. 9 in the not lifted-out position;

FIG. 11 shows a sectional view along the line 11,12-11,12 according to FIG. 6 in the lifted-out position; and

FIG. 12 shows the same view as FIG. 11 in the not lifted-out position.

### DETAILED DESCRIPTION OF THE INVENTION

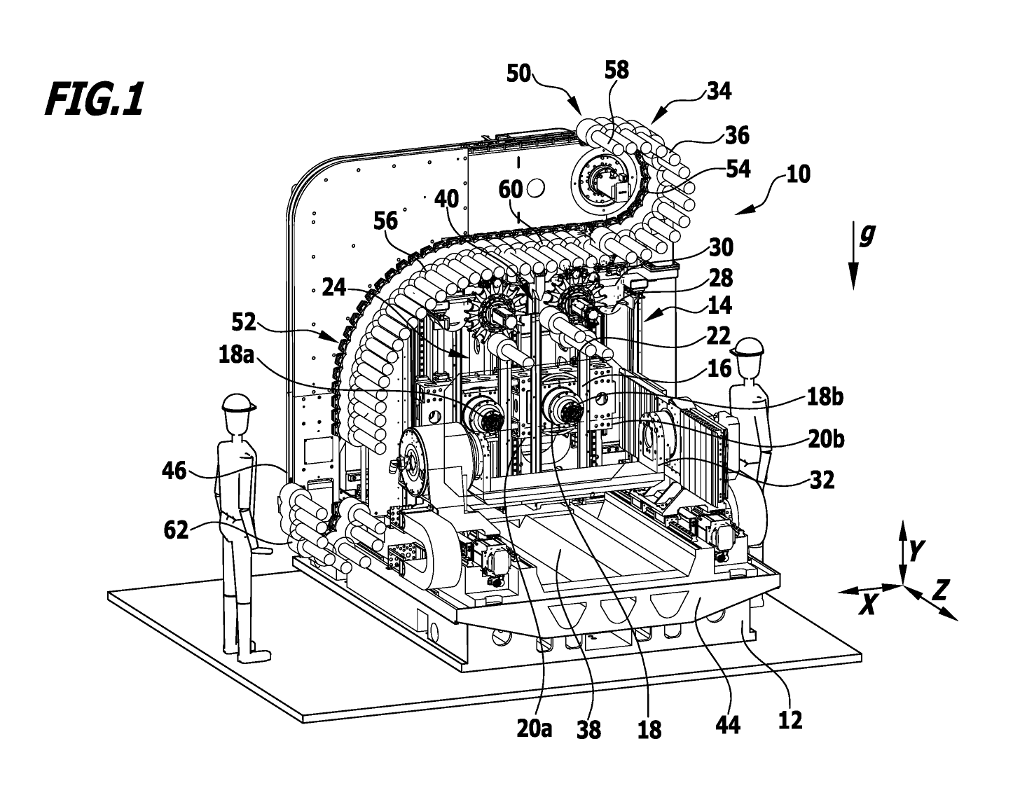

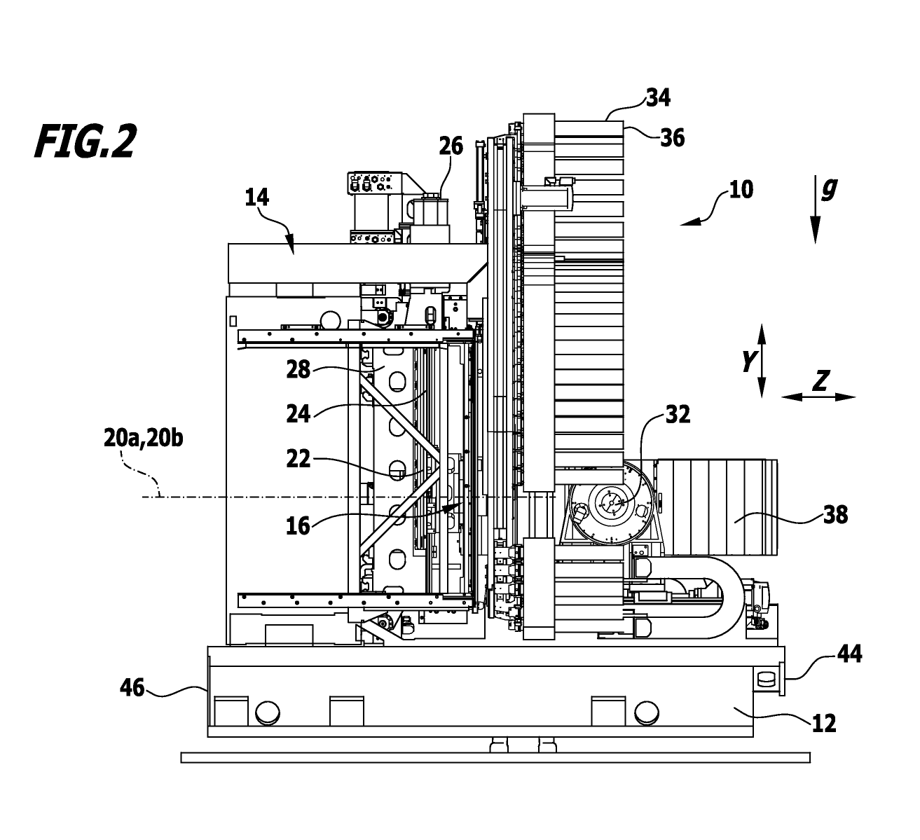

One exemplary embodiment of a machine tool is a machining center. One embodiment of a machining center, which is shown schematically in FIGS. 1 to 3 in a partial representation (without the cover) and is identified as 10 there, comprises a machine bed 12 on which a machine frame 14 is arranged. The machine frame 14 has a portal type of configuration and extends beyond the machine bed 12 in a vertical direction relative to the direction of gravity g. Mounted on the machine frame 14 is a tool carrier device 16 which comprises at least one tool spindle 18.

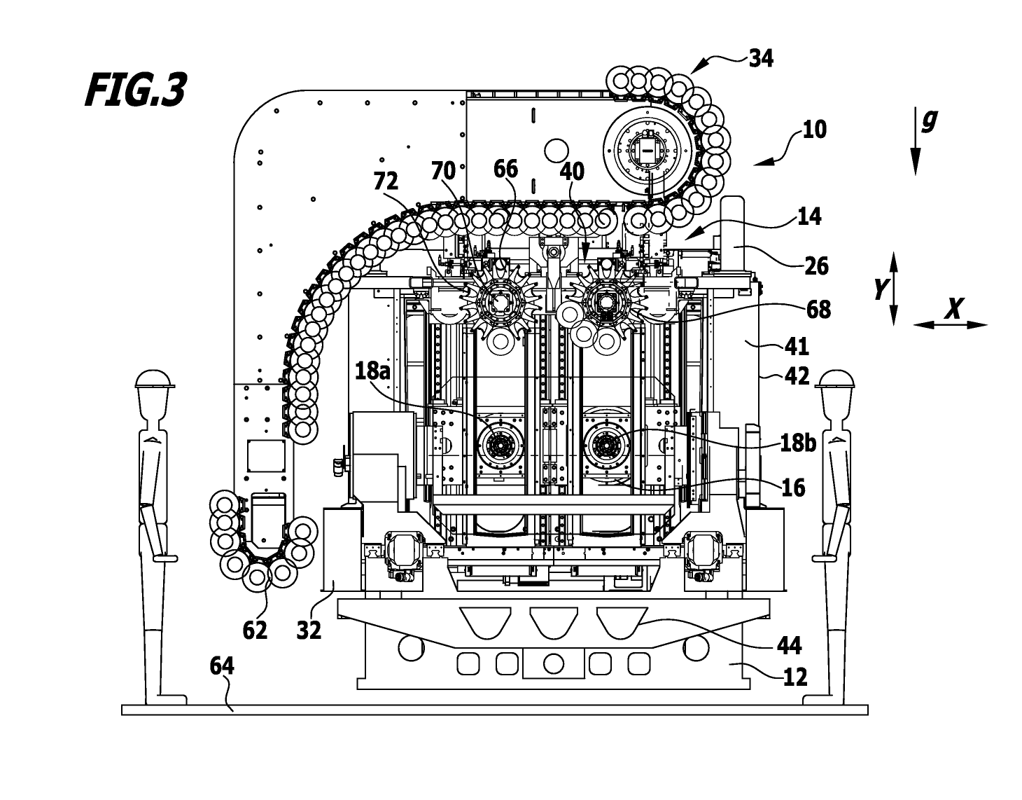

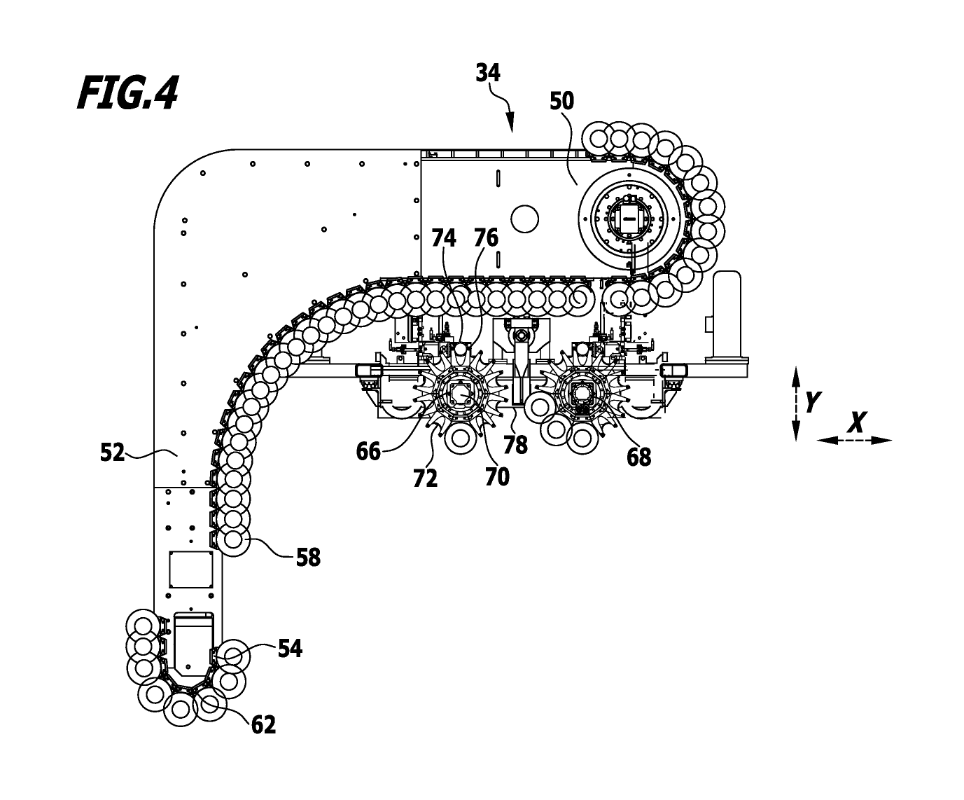

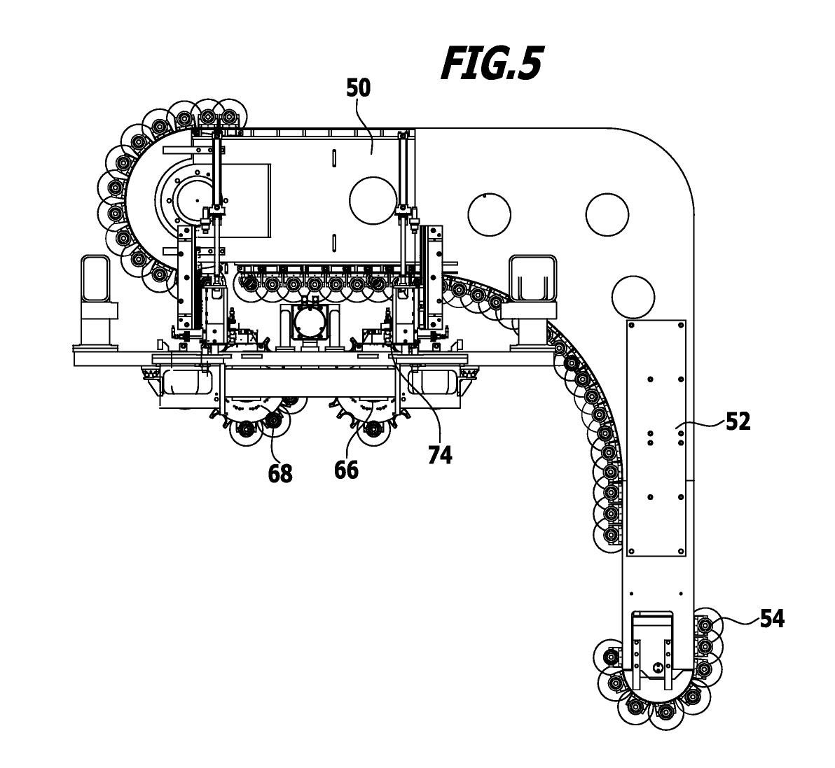

In the exemplary embodiment shown, the tool carrier device 16 comprises a first tool spindle 18a and a second tool spindle 18b. A tool held at the respective tool spindles 18a, 18b is rotatable about a rotation axis 20a, 20b. The rotation axes 20a, 20b lie parallel to one another. They are oriented parallel to a Z-direction which, in the representation according to FIG. 3, lies perpendicularly to the drawing plane. The Z-direction is, in particular, a horizontal direction relative to the gravity direction g.

The tool carrier device 16 is configured as a carriage 22 which is held on a carriage guideway 24 and is linearly movable via the carriage guideway 24 in a Y-direction (forward and backward). The Y-direction lies transversely and, in particular, perpendicularly to the Z-direction. The Y-direction is, in particular, a vertical direction relative to the gravity direction g.

In order to drive the movement of the carriage 22 in the Y-direction and for positioning thereof, a drive device 26 is associated with the carriage 22. Said drive device can comprise a lead screw drive or a linear motor.

The carriage 22 is itself held on a carriage 28 which is linearly displaceable in an X-direction (forward and backward) on a carriage guideway 30. For displacement and positioning, a corresponding drive is provided. The X-direction is transverse and, in particular, perpendicular to the Y-direction and the Z-direction. The X-direction is, in particular, a horizontal direction relative to the gravity direction g.

At least one workpiece holder 32 is arranged on the machine bed 12. The first tool spindle 18a and the second tool spindle 18b and therefore tools held thereon and the workpiece holder 32 are movable relative to one another in the Z-direction (forward and backward). A workpiece held on the workpiece holder 32 and the tool spindle 18a or 18b are therefore displaceable relative to one another in the X-direction as the first direction, the Y-direction as the second direction and the Z-direction as the third direction.

In one exemplary embodiment, the tool spindles 18a, 18b are not moveable in the Z-direction for machining a workpiece and the workpiece holder 32 is held on the machine bed displaceably in the Z-direction. For this purpose, a drive is associated with the workpiece holder 32.

In an alternative exemplary embodiment, the first tool spindle 18a and the second tool spindle 18b are displaceably held on the tool carrier device 16 in order to enable a Z-displaceability.

It is also possible to combine a Z-displaceability of the tool spindles 18a, 18b at the tool carrier device 16 and a Z-displaceability of the workpiece holder 32 on the machine bed.

It can also be provided, for example, that the workpiece holder 32 is rotatable, for example, about a vertical axis and/or a horizontal axis.

A machining center of this type is disclosed, for example, in WO2009/033920 A1. Reference is made to this document, which is also incorporated within the present disclosure.

In the exemplary embodiment illustrated, the machining center 10 has a storage device 34 for tools 36 which is arranged with a part thereof above a working space 38 in which workpieces are machined. The tools 36 are indicated with the interfering contours (maximum external dimensions) thereof.

Furthermore, a tool changing device 40 is provided by means of which tools 36 can be inserted on, and removed from, the tool spindles 18a and 18b.

The machining center 10 may also comprise only a single tool spindle or more than two tool spindles.

The machining center 10 has a control device 41 which is arranged at least partially in a switchgear cabinet 42. Sequences of the workpiece machining can be controlled with the control device 41.

The machining center 10 has a front side 44 and a rear side 46. The working space 38 faces the front side 44.

The storage device 34 is part of a storage system 48. The storage device 34, which is arranged on the machine frame 14, comprises a first region 50 which is arranged above the working space 38. Furthermore, the storage device 34 comprises a second region 52 which is arranged laterally beside the working space. The storage device 34 has an L-shaped form in plan view. The storage device comprises a circulating conveyor 54 which is configured, in particular, as a chain conveyor. Storage spaces 56 are arranged on the circulating conveyor 54, each storage space 56 being able to receive a tool 58. A storage space 56 has a suitable interface, for example, for an HSK mounting. With the circulating conveyor 54, the storage spaces 56 and thus also the tools 58 can be transported in a closed circuit. In this way, tools 58 can be provided to the tool spindles 18a, 18b in a region 60 above (relative to the direction of gravity g) the working space 38.

At a bottom side 62, the second region 52 of the storage device 34 is at a spacing (see, in particular, FIG. 3) of no more than 1.5 m from a floor 64. Therefore, an operator can load and unload the storage device 34 in the vicinity of the bottom side 62, which means, in particular, that tools can be exchanged manually there. It is also possible, for example, for a dedicated tool loading/unloading station to be associated with the second region 52, by means of which the storage device 34 is automatically loadable and unloadable.

The storage device 34 constitutes a first magazine for tools for the machine tool 10. It has a plurality of storage spaces 56. In particular, the storage device has more than thirty storage spaces. In one exemplary embodiment, the first storage device 34 has ninety-two storage spaces 56.

The storage system 48 also comprises a first disk-type storage unit 66 and a second disk-type storage unit 68. The first disk-type storage unit 66 is associated with the first tool spindle 18a and the second disk-type storage unit 68 is associated with the second tool spindle 18b.

The disk-type storage units 66, 68 are each rotatable about an axis 70 on the machine frame 14. The rotary axis 70 is oriented parallel to the Z-direction.

The first disk-type storage unit 66 and the second disk-type storage unit 68 are spaced apart from one another in the X-direction. This spacing between the first disk-type storage unit 66 and the second disk-type storage unit 68 is, in particular, fixed.

The first disk-type storage unit 66 and the second disk-type storage unit 68 are arranged between the working space 38 and the first region 50 of the storage device 34. They are, in particular, positioned beneath the first region 50 of the storage device 34 and above the working space 38. The first disk-type storage unit 66 and the second disk-type storage unit 68 communicate with the storage device 34 (specifically with the first region 50 therein) and the associated tool spindles 18a and/or 18b.

A disk-type storage unit 66 or 68 has a plurality of storage spaces 72 which are arranged on a circular disk. A storage space 72 comprises, for example, an HSK interface. The storage spaces 72 are distributed round the periphery of the respective disk-type storage unit 66 or 68, specifically such that a tool stored at a storage space 72 can be removed from outside.

The disk-type storage units 66 and 68 constitute a second magazine (buffer magazine) for tools, wherein the number of storage spaces 72 in the first disk-type storage unit 66 and the second disk-type storage unit 68, respectively, is smaller than the number of storage spaces 56 in the storage device 34. For example, the first disk-type storage unit 66 and the second disk-type storage unit 68 each have a total of ten storage spaces 72.

In particular, the first disk-type storage unit 66 and the second disk-type storage unit 68 are configured to be identical.

At least one transfer station 74 is provided which serves to transfer tools between the storage device 34 and the respective disk-type storage unit 66, 68. The transfer station 74 has at least one space 76 for a tool. By means of this space 76, a tool can be received at the relevant disk-type storage unit 66, 68 and transported to the storage device 34 (at the first region 50 there) or, conversely, a tool can be removed from the disk-type storage unit 34 and then transported to the corresponding disk-type storage unit 66 or 68.

In one exemplary embodiment, the transfer station 74 comprises two spaces 76 so that two tools can be received simultaneously.

The transfer station 74 is configured to be movable in order to enable transfer between the storage device 34 and the respective disk-type storage unit 66, 68.

The transfer station 74 comprises, for example, a carriage for a linear movement between the first region 50 of the storage device 34 and the corresponding disk-type storage unit 66, 68 or, for example, a pivotable element.

In particular, a respective transfer station 74 is associated with each of the first disk-type storage unit 66 and the second disk-type storage unit 68.

It is also possible, in principle, for the first disk-type storage unit 66 and the second disk-type storage unit 68 to be arranged on a carriage which is movable on the machine frame 14. Said carriage is movable, for example, in the Y-direction or in the X-direction or in the Y-direction and the X-direction.

A transfer device can be formed by a carriage of this type. Through the movement of the carriage, the disk-type storage units 66, 68 can be driven into the vicinity of the first region 50 of the storage device in order to enable a direct transfer.

It is also possible, even if transfer stations 74 are provided, for the first disk-type storage unit 66 and the second disk-type storage unit 68 to be arranged on a carriage 78 which is movable in the X-direction and/or the Y-direction and/or the Z-direction. The carriage can therefore be guided with the first disk-type storage unit 66 and the second disk-type storage unit 68 to the tool spindles 18a, 18b.

It is alternatively possible, for a tool change, that the tool spindles 18a, 18b are guided to the disk-type storage units 66, 68 in such a way that a tool change is enabled.

It can also be provided, for example, that the carriage 78 has movability only in the Z-direction. The Z-direction is parallel to a longitudinal extent of the tool spindles 18a, 18b. A suitable displaceability of the carriage 78 in the Z-direction enables a lifting-out movement for a tool to be made.

The machine tool according to the invention has the following functions in relation to tool replacement.

The first storage device 34 constitutes a background (first) magazine for tools. With the disk-type storage units 66, 68, wherein precisely one disk-type storage unit is associated with each tool spindle (the first disk-type storage unit 66 is associated with the first tool spindle 18a and the second disk-type storage unit 68 is associated with the second tool spindle 18b), a buffer store for tools is provided wherein the transfer station or transfer stations 74 provide for the transfer of tools between the storage device 34 and the disk-type storage units 66, 68. The tool spindles 18a, 18b fetch tools from the disk-type storage units 66, 68 or deliver tools thereto. (The delivery process or the fetching process can be carried out actively by means of the tool spindles 18a, 18b in that said tool spindles move toward the disk-type storage units 66, 68, or a passive process is possible in principle, in that if the disk-type storage units 66, 68 are arranged on the carriage 78, the carriage 78 moves toward the tool spindles 18a, 18b. A combined active approach of both the tool spindles 18a, 18b and the carriage 78 is also possible.)

The disk-type storage units 66, 68 each accept a smaller number of tools than the storage device 34.

In principle, the storage system 48 with the background magazine (the storage device 34) and the buffer stores (the first disk-type storage unit 66 and the second disk-type storage unit 68) has a large capacity for accommodating tools. Since a relatively large number of tools can be held in reserve in the disk-type storage units 66, 68 and said storage units are arranged directly at the edge of the working space 38, even during relatively complex machining operations for which a plurality of tools is required, a short provision time can be realized for tools for the tool spindles 18a, 18b. The result is a short chip-to-chip time of, for example, less than 3 s.

The background magazine 34 permits a tool change to be performed easily and rapidly at the disk-type storage units 66, 68.

Since each tool spindle 18a, 18b is associated with one, and particularly precisely one, disk-type storage unit 66 or 68, a rapid tool replacement can be provided even if a tool replacement is to be carried out, particularly synchronously, at a plurality of tool spindles. In particular, in this way, synchronous machining operations can be carried out on two workpieces within the same machine tool and with short chip-to-chip times.

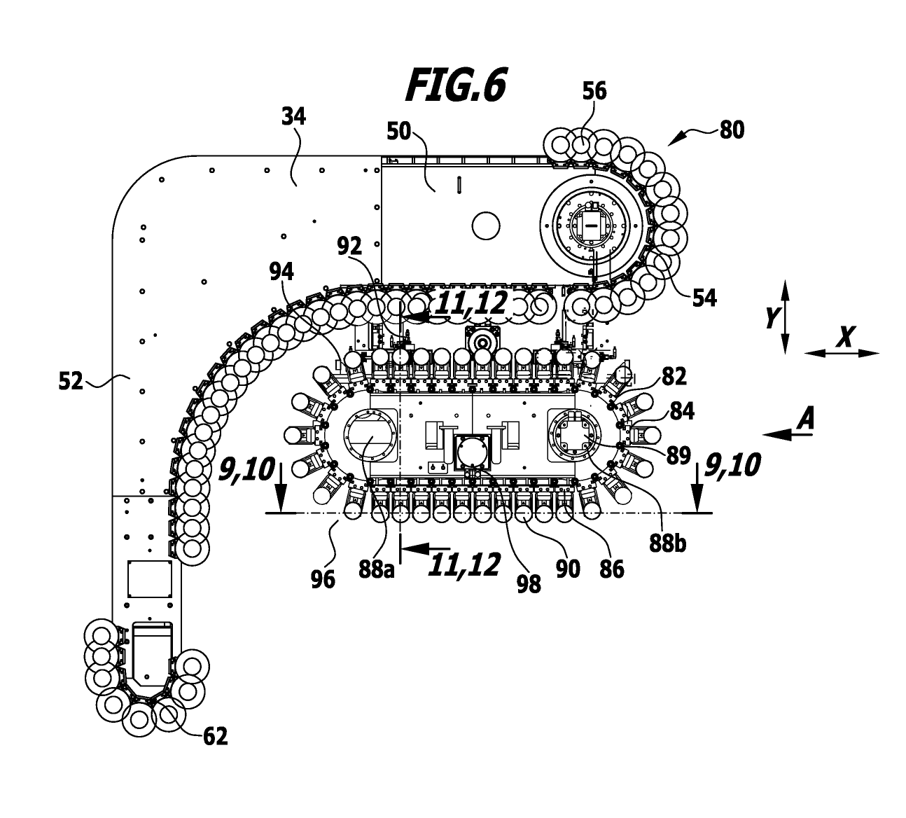

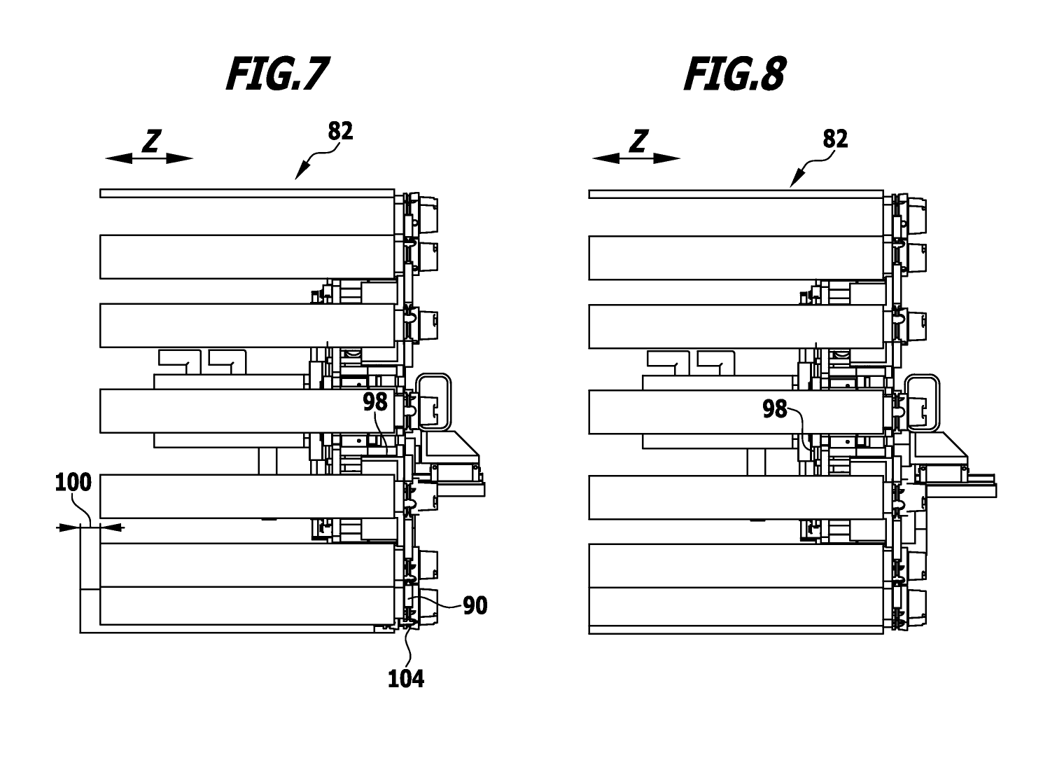

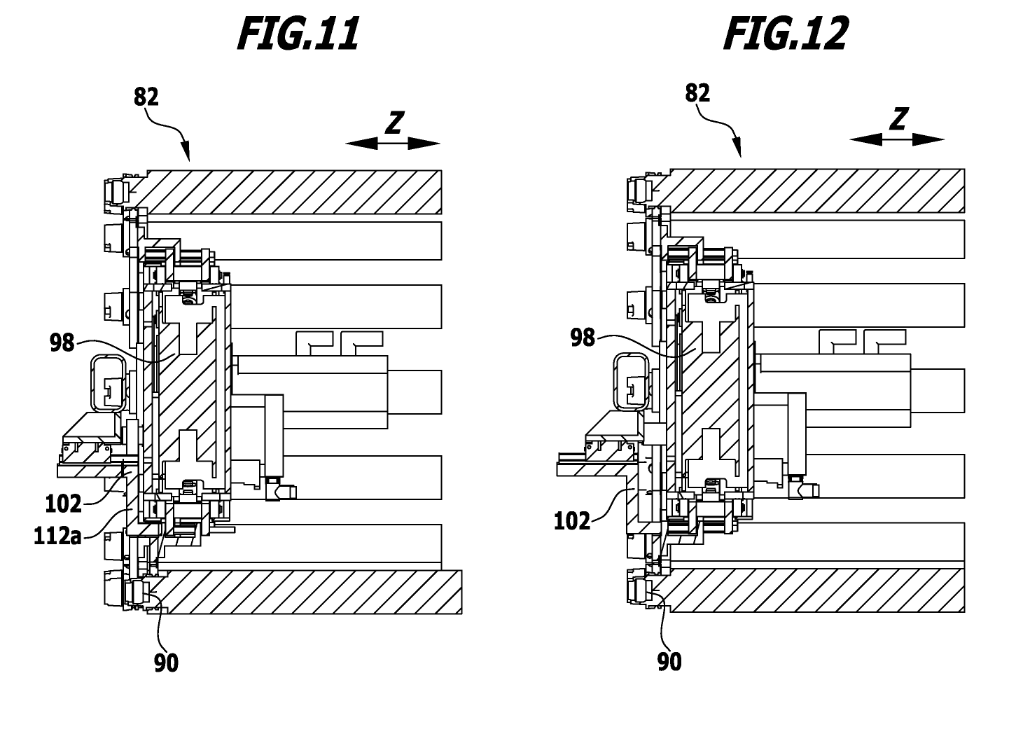

A further exemplary embodiment of a storage system as shown in FIGS. 6 to 11 and identified there as 80, comprises a storage device arranged on the machine frame 14 and corresponding to the storage device 34. Therefore, the same reference signs are used for identical elements. This storage device 34 itself constitutes a background magazine with a large number of storage spaces 56.

The storage system 80 has a chain-type storage device 82 as the second magazine. Said chain-type storage device 82 is arranged between the working space 38 and the first region 50 of the storage device 34. It is arranged, in particular, beneath the first region 50 and above the working space 38. The chain-type storage device 82 is arranged, in particular non-displaceably, on the machine frame 12. It comprises a circulating chain conveyor 84. Said circulating chain conveyor 84 has a chain 86 which is mounted, for example, on deflection rollers 88a, 88b. The chain 86 is configured endless and is closed. A circulating movement of the chain 86 on the deflection rollers 88a, 88b is driven by a drive 89. It is possible for a movement of the chain 86 to take place only in one direction or both forward and backward.

A plurality of storage spaces 90 is provided on the chain 86. For example, the storage spaces 90 each comprise a hollow taper shank (HSK) interface 91. Each storage space 90 is in a fixed relation to the chain 86 so that, when the chain 86 is transported, the storage spaces 90 are also transported.

The number of storage spaces 90 in the chain-type storage device 82 is smaller than the number of storage spaces 56 in the storage device 34. In one exemplary embodiment, the chain-type storage device 82 has thirty-four storage spaces 90.

One or more transfer stations 92 are associated with the chain-type storage device 82. A transfer station 92 has, in particular, one or more movable spaces corresponding to the spaces 76 so that a tool transfer from the storage device 34 to the chain-type storage device 82 can take place and vice versa. The chain-type storage device 82 communicates via the transfer station or transfer stations 92 with the first region 50 of the storage device 34.

The chain-type storage device 82 has a region 94 which faces toward the first region 50 of the storage device 34. It has an opposing region 96 which faces toward the machine bed 12. A transfer of tools between the tool spindles 18a, 18b and the chain-type storage device 82 can take place at the region 96. Via the region 96, the chain-type storage device 82 communicates with the tool spindles 18a, 18b.

The chain-type storage device 82 serves for changing tools both with the first tool spindle 18a and also with the second tool spindle 18b. For this purpose, the chain-type storage device 82 has a corresponding extent in the X-direction so that both the first tool spindle 18a and the second tool spindle 18b can be served by the chain-type storage device 82 and, in particular, by the region 96 thereof.

A lifting-out device 98 is arranged on the chain-type storage device 82. The lifting-out device 98 is associated with the tool spindles 18a, 18b. It is arranged at a lower region of the chain-type storage device facing toward the working space 38, said region comprising the region 96. Using the lifting-out device 98, a lifting-out movement can be performed at the chain-type storage device 82 in a direction parallel to a longitudinal extent of the tool spindle 18a, 18b, that is in the Z-direction. Said movement moves a storage space 90 with the corresponding interface 91. A typical lifting-out travel 100 (stroke) is in the order of 40 mm. With a lifting-out movement, a tool can be released from a tool spindle 18a, 18b or with a reverse lifting-out movement, a tool can be inserted into a tool spindle 18a, 18b and fixed.

It is possible, in principle, as described above, for the lifting-out device 98 to act upon a storage space in order to move the tool or to act directly upon a tool and to displace said tool directly.

In one exemplary embodiment, the lifting-out device 98 has a first lifting-out region 102 and a second lifting-out region 104. The first lifting-out region 102 is associated, in particular, with the first tool spindle 18a and the second lifting-out region 104 is associated with the second tool spindle 18b.

A lifting-out region 102 or 104 can act upon one or more storage spaces 90. In the case of the exemplary embodiment disclosed, each lifting-out region 102 or 104 acts upon three storage spaces.

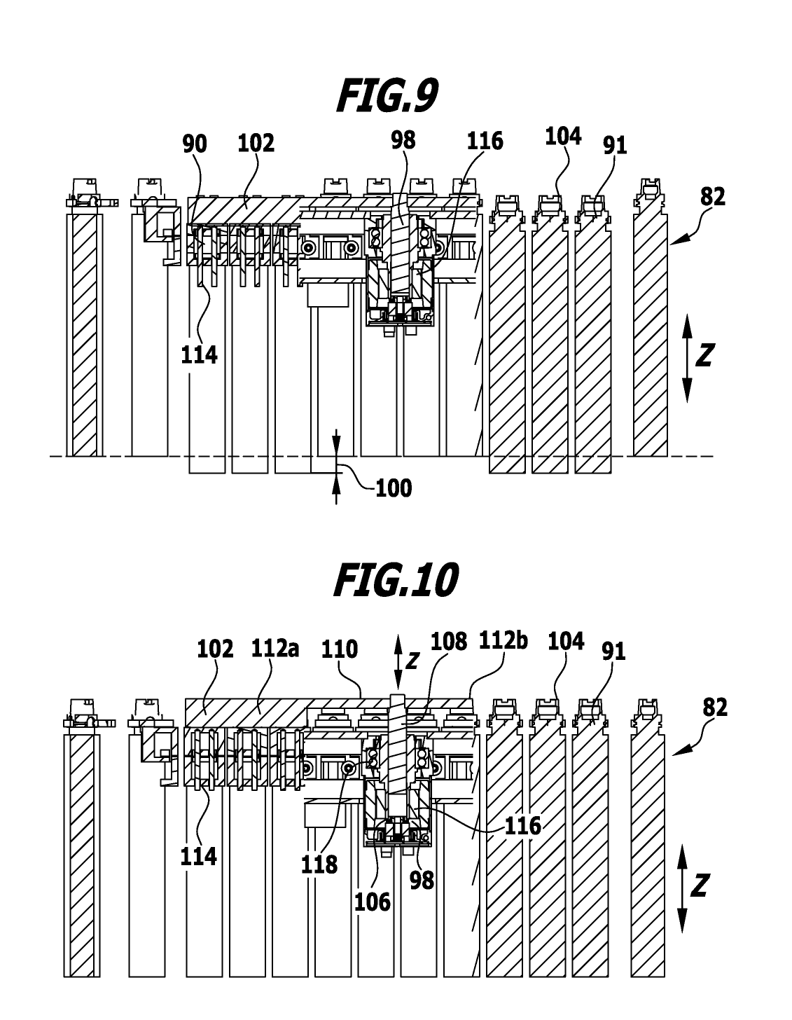

In one exemplary embodiment (see, in particular, FIGS. 9 and 10), the lifting-out device 98 comprises a central unit 106. Said device has a spindle 108 which is displaceable in the Z-direction. The first lifting-out region 102 and the second lifting-out region 104 are symmetrical to the spindle 108. For example, a bar 110, having a first region 112a and a second region 112b, is firmly connected to the spindle 108 and is therefore displaceable therewith. The first region 112a acts upon storage spaces 90 at one side of the spindle 108 (for example, to the left of the spindle 108) and the second region 112b acts upon storage spaces 90 at the other side of the spindle 108 (for example, to the right of the spindle 108).

For this purpose, the regions 112a, 112b are connected to pushing elements 114 of the respective storage spaces 90. By means of a Z-displacement of the spindle 108, via the bar 110, the pushing elements 114 are displaced and act on a corresponding tool held at the storage space 90 of said tool and displace the tool in the Z-direction, i.e. bring about the lifting-out travel 100.

A drive 116 is associated with the spindle 108 in order to cause the corresponding lifting movement. In principle, said drive 116 can be a motor drive or a fluid-powered drive. It is, for example, also possible for the drive 116 to consist of one or more elastic springs.

In one exemplary embodiment, the drive 116 is provided by means of an actuator which comprises a servomotor and a lead screw drive 118. The spindle 108 is part of the lead screw drive 118. The servomotor provides for the positioning and fixing of the spindle 108 in the +Z and −Z positions.

In an example shown in FIG. 10, the corresponding pushing elements 114 are not extended.

FIG. 9 shows the extended position. By means of the drive 116, the spindle 108 is driven in the Z-direction and thereby also moves the pushing elements 114.

In order to return the spindle, a return spring by means of which the non-extended position is reached can also be provided. It is also possible, in principle, for a spring to be provided in order to bring about the movement from the non-extended position into the extended position.

By means of the lead screw drive 118 with servomotor, the transition between the extended position and the non-extended position and conversely, between the non-extended position and the extended position can be brought about without any additional spring action and the corresponding positions shown can be fixed.

The storage system 80 according to the invention functions as follows.

The storage device 34 constitutes a background magazine with a larger number of storage spaces than the chain-type storage device 82. The chain-type storage device 82 constitutes a second tool magazine as a buffer store. The tool spindles 18a, 18b fetch tools directly from the chain-type storage device 82 or deliver tools thereto. The chain-type storage device 82 can accommodate a plurality of tools wherein the number of storage spaces 90 is smaller than the number of storage spaces 56 of the L-shaped storage device 36.

The chain-type storage device 82 has designated storage spaces, specifically those storage spaces on which the lifting-out device 98 acts. By means of the circulating chain conveyor 84, storage spaces 90 can be “converted” into such designated storage spaces, i.e. said storage spaces can be transported into the region of action of the lifting-out device 98.

The lifting-out device 98 is symmetrically constructed so that lifting-out from one or more storage spaces can be achieved with effect both for the first tool spindle 18a and also for the second tool spindle 18b.

The tool spindles 18a, 18b move toward storage spaces which are raised, i.e. pushed forward in the Z-direction, by means of a movement in the X-direction. In connection therewith, the tool spindles 18a, 18b have been brought with a prior movement in the Y-direction to the correct height position for a tool change.

The lifting-out device 98 brings about a lifting-out stroke of preferably at least two storage spaces 90. In this way, the respective tool spindle 18a or 18b can hand over a tool at the associated region of the chain-type storage device 82 at a storage space and, with a corresponding method, fetch a new tool at a further storage space. In the process, no further lifting-out movement need be performed therebetween for the respective tool spindle 18a, 18b. This saves time. Following the tool change and the movement away of the relevant tool spindle 18a or 18b, all the raised storage spaces can be reset through the return movement at the lifting-out device 98. This also saves time.

During the tool change with the lifting-out device 98, no circulation of the chain 86 takes place at the chain-type storage device 82.

Therefore, simultaneously with the tool change at the tool spindles 18a, 18b, a tool exchange can take place between the storage device 34 and the chain-type storage device 82. Therefore, the down time necessary for the exchange of tools at the tool spindles 18a, 18b can also be efficiently used for a tool change between the chain-type storage device 82 and the storage device 34.

Therefore, even in the case of complex workpiece machining operations for which a plurality of different tools must be provided, short chip-to-chip times can be achieved. A tool replacement can be carried out in a time-saving manner.

### REFERENCE SIGNS

10 Machining center
12 Machine bed
14 Machine frame
16 Tool carrier device
18a First tool spindle
18b Second tool spindle
20a Rotation axis
20b Rotation axis
22 Carriage
24 Carriage guideway
26 Drive device
28 Carriage
30 Carriage guideway
32 Workpiece holder
34 Storage device
36 Tool
38 Working space
40 Tool replacement device
41 Control device
42 Switchgear cabinet
44 Front side
46 Rear side
48 Storage system
50 First region
52 Second region
54 Circulating conveyor
56 Storage location
58 Tool
60 Region
62 Bottom side
64 Floor
66 First disk-type storage unit
68 Second disk-type storage unit
70 Axis
72 Storage location
74 Transfer station
76 Space
78 Carriage
80 Storage system
82 Chain-type storage device
84 Circulating chain conveyor
86 Chain
88a,b Deflection roller
89 Drive
90 Storage location
91 Hollow taper shank interface
92 Transfer station
94 Region
96 Region
98 Lifting-out device
100 Lifting-out travel
102 First lifting-out region
104 Second lifting-out region
106 Central unit
108 Spindle
110 Bar
112a First region
112b Second region
114 Pushing element
116 Drive
118 Lead screw drive

1. A machine tool comprising:
a machine frame;
at least one tool spindle which is arranged on the machine frame and is displaceable relative thereto;
a workpiece holder; and
a storage device for tools which is arranged on the machine frame;
wherein a chain-type storage device is provided which communicates with the storage device and with the at least one tool spindle.

2. The machine tool according to claim 1, wherein the chain-type storage device is associated with at least one first tool spindle and a second tool spindle.

3. The machine tool according to claim 1, wherein the storage device constitutes a first magazine for tools and the chain-type storage device constitutes a second magazine for tools.

4. The machine tool according to claim 3, wherein a storage capacity for tools of the first magazine is greater than the storage capacity of the chain-type storage device.

5. The machine tool according to claim 1, wherein the storage device has at least 30 storage spaces for tools.

6. The machine tool according to claim 1, wherein the chain-type storage device has in the range of 30 to 50 storage spaces for tools.

7. The machine tool according to claim 1, wherein the storage device has a region with storage spaces which lies above a working space and has a region which lies beside the working space.

8. The machine tool according to claim 7, wherein the region which lies beside the working space is at a distance of not more than 1.5 m from a substrate on which a machine bed stands.

9. The machine tool according to claim 1, wherein the storage device has an L-shaped form in plan view.

10. The machine tool according to claim 1, wherein the storage device comprises a circulating conveyor.

11. The machine tool according to claim 1, wherein the chain-type storage device comprises a circulating chain conveyor.

12. The machine tool according to claim 1, wherein the chain-type storage device comprises a lifting-out device by means of which one or more tools are displaceable in a direction parallel to a longitudinal direction of the at least one tool spindle.

13. The machine tool according to claim 12, wherein the lifting-out device provides a lifting-out travel in the range between 20 mm and 60 mm.

14. The machine tool according to claim 12, wherein the lifting-out device comprises at least one first lifting-out region and a second lifting-out region by means of which at least one of one or more storage spaces and tools is adapted to be lifted out.

15. The machine tool according to claim 14, wherein the first lifting-out region and the second lifting-out region are arranged symmetrical to one another.

16. The machine tool according to claim 12, wherein by means of the lifting-out device, at least one of one or more storage spaces and tools which are positioned at an underside of the chain-type storage device which faces a machine bed is adapted to be lifted out.

17. The machine tool according to claim 12, wherein the lifting-out device comprises at least one displaceable spindle which is associated with one or more storage spaces of the chain-type storage device.

18. The machine tool according to claim 17, wherein the at least one spindle is associated with a displacement actuator.

19. The machine tool according to claim 18, wherein the displacement actuator comprises a drive.

20. The machine tool according to claim 17, wherein the at least one spindle is part of a ball screw drive.

21. The machine tool according to claim 1, said machine tool comprising at least one transfer station between the storage device and the chain-type storage device.

22. The machine tool according to claim 1, wherein the chain-type storage device is arranged and configured such that, at the same time as a tool replacement at the at least one tool spindle it is possible for a tool change to be carried out between the storage device and the chain-type storage device.

23. A method for tool replacement on a machine tool comprising:
a machine frame;
at least one tool spindle which is arranged on the machine frame and is displaceable relative thereto;
a workpiece holder; and
a storage device for tools which is arranged on the machine frame;
wherein a chain-type storage device is provided which communicates with the storage device and with the at least one tool spindle;
wherein in the tool replacement method the at least one tool spindle approaches the chain-type storage device; and
wherein at least one of a storage space and a tool is lifted out at the chain-type storage device in a direction parallel to a longitudinal axis of the at least one tool spindle.

24. The method according to claim 23, wherein, simultaneously with a tool replacement between the at least one tool spindle and the chain-type storage device, a tool change is carried out between the storage device and the chain-type storage device.

25. The method according to claim 23, wherein for a tool change at the at least one tool spindle, at least one bring space for a tool and one fetch space for a tool are lifted simultaneously.
